(19) United States
(12) Patent Application Publication
(10) Pub. No.: US 2026/0294715 A1
(43) Pub. Date: Oct. 1, 2026

(54) AMUSEMENT RIDE, IN PARTICUAR ROLLER COASTER, AND METHOD FOR OPERATING SUCH AN AMUSEMENT RIDE

(71) Applicant: MACK RIDES GMBH & CO. KG, Waldkirch (DE)

(72) Inventors: Joachim ROETTGER, Villingen-Schwenningen (DE); Gregor ENGELMANN, Herbolzheim (DE)

(21) Appl. No.: 19/476,985

(22) PCT Filed: Dec. 12, 2023
(86) PCT No.: PCT/EP2023/085332

§ 371 Date: Oct. 20, 2025

(30) Foreign Application Priority Data
Apr. 20, 2023 (DE) 102023110118.8

(51) Int. Cl. A61G 7/10; A63G 7/00

(52) U.S. Cl. CPC A61G 7/1001; A61G 7/1015; A61G 7/1051; A61G 7/1076; A61G 7/109; A63G 7/00; A61G 2200/34

(57) ABSTRACT

The invention relates to an amusement ride (1), in particular a roller coaster, a water amusement ride, a dark ride, a carousel, or a circular amusement ride, having at least one vehicle (2) and an entry and/or exit region (8). The at least one vehicle has at least one occupant receiving area for at least one occupant, and a transfer unit (10) is arranged in the entry and/or exit region (8), wherein the transfer unit (10) can lift the at least one occupant (7) from the entry and/or exit region (8) to the at least one occupant receiving area (4) on a seat support (20). The invention additionally relates to a method for operating an amusement ride (1).

The present invention relates to an amusement ride having the features of claim 1 and to a method for operating an amusement ride having the features of claim 12.

Amusement rides are known from the prior art in various configurations and are provided as stationary or semi-stationary installations or attractions, in particular in amusement parks, for the leisure entertainment of occupants. Typical amusement rides can be, for example, water rides, roller coasters, dark rides, carousels or roundabouts, which have at least one vehicle that can travel along a route. The at least one vehicle can have at least one receiving area for accommodating at least one occupant, wherein typically a plurality of receiving areas are provided, each of which can accommodate one occupant.

In the prior art, the receiving areas are typically designed as seats and have widespread restraint systems to hold the occupant safely in the receiving area during the ride. In the case of roller coasters, safety bares, which are held on the back of the receiving area, for example, and can be swiveled from an open position to a closed position in which the occupant is held in the seat switch or receiving area in a form-locking manner, have proven particularly effective.

The at least one occupant can, as intended, enter and exit the at least one vehicle in an entry and/or exit region, wherein, in the context of the present invention, the entry and/or exit region may also be referred to as the boarding platform of a railroad station or a station. The at least one vehicle interrupts the ride at the entry and/or exit region and the at least one occupant can preferably move barrier-free from the entry region into the at least one vehicle or from the at least one vehicle into the exit region.

Amusement rides should be an attractive offer for a wide audience, but it is a challenge to make this offer equally accessible to people with physical disabilities. Complex special devices are often required on the vehicles to enable people with physical disabilities to be carried or transferred. There are also considerable delays in the entry and/or exit region when entering or exiting, which interrupt the throughput-optimized operation of the amusement ride.

This is where the present invention comes in.

The present invention is therefore devoted to the object of providing an improved amusement ride, in particular an improved water ride, an improved roller coaster, an improved dark ride, an improved carousel and/or an improved roundabout ride, which suitably improves the amusement rides known from the prior art. The amusement ride to be proposed should enable people with physical disabilities to use the ride as barrier-free as possible, without the respective vehicle having to carry separate receiving areas. Furthermore, throughput-optimized operation should be possible.

These objects are achieved by an amusement ride having the features of claim 1 and by a method for operating an amusement ride having the features of claim 12.

Further advantageous embodiments of the invention are given in the dependent claims.

The amusement ride according to the invention, in particular a roller coaster or a water ride, with the features of claim 1 has at least one receiving area for at least one occupant and an entry and/or exit region. The at least one occupant can take a seat, preferably seated, on the at least one receiving area during the ride with the amusement ride and travel along a route. The receiving area is preferably designed as a seat or seat shell. Furthermore, the amusement ride according to the present invention has a transfer unit in the entry and/or exit region, wherein the transfer unit can lift the at least one occupant on a seat support from the entry and/or exit region into the at least one receiving area and preferably vice versa.

The present invention is based on the idea of facilitating access to the amusement ride, in particular for people with physical disabilities, by enabling the at least one occupant to be lifted from the entry and/or exit region by means of the transfer unit into the receiving area intended for them, or a receiving area desired by them, or any receiving area. Here, the transfer unit lifts the at least one occupant with a seat support. The occupant can drive into the entry and/or exit region with their means of transportation or walking aid, in particular with their wheelchair, and is lifted out of the walking aid together with the seat cover and into the receiving area. The transfer unit creates an amusement ride in which the passive occupant can be both lifted into and out of a receiving area.

The transfer unit eliminates the need for personnel-intensive and physically strenuous “transferring” of at least one occupant in extremely limited space. It is often not even permitted for staff to transfer at least one occupant. In such cases, at least one occupant must be transferred independently or with the help of an escort.

During the ride on the amusement ride, the seat support remains between at least one occupant and the receiving area.

At the end of the ride, the at least one occupant can be lifted out of the receiving area in the same manner by means of the transfer unit and set down again in the entry and/or exit region, for example in their walking aid.

Furthermore, it has proven to be advantageous if the amusement ride comprises at least one vehicle that can travel along a route. The at least one vehicle comprises the at least one receiving area. The at least one occupant can board the at least one vehicle at the entry and/or exit region as intended and take a seat on the at least one seat support as intended.

According to a preferred embodiment of the present invention, the transfer unit can perform at least a lifting and lowering movement and a translational movement. The lifting and lowering movement serve to raise and/or lower or lift the at least one occupant into or out of the at least one receiving area and/or the walking aid and/or a means of occupant transportation, such as a wheelchair. The translational movement serves to transport the at least one occupant from the entry and/or exit region into or onto the at least one receiving area, in particular the receiving area of a vehicle. Preferably, the at least one occupant positioned on the seat support is lifted from the boarding platform-for example into the vehicle-via a platform edge and vice versa. The translational movement can typically be transverse to the orientation of the boarding platform or a direction of travel-in particular of the at least one vehicle. The movement of the transfer unit can also comprise a rotational movement of the occupant. The lifting and lowering movement, the translational movement and/or the rotational movement can be superimposed.

A preferred further embodiment of the present invention provides that the seat support is flexible. The seat support is preferably made of a material that adapts to the shape of the body and can be designed, for example, as a seat mat, seat belt, beanbag, sling, seat shell or similar. The at least one occupant does not necessarily have to sit on the seat support only during the ride with the amusement ride, but can also, in an exemplary embodiment, sit on the seat support for the entire duration of the stay in the amusement ride or in the amusement park.

Therefore, the seat support should also meet the requirements of an ergonomic seat support in a preferred design and be breathable. The seat support should also be easy to clean, wash and/or disinfect.

In accordance with a further embodiment of the present invention, first connecting means are arranged to provide a detachable connection between the transfer unit and the seat support. The first connecting means enable the seat support to be connected to the transfer unit securely and quickly, and the connection to be released quickly and easily. Typically, the first connecting means comprise a first and a second connecting means part which interact with one another. The first connecting means part can be firmly arranged on the transfer unit and the second connecting means part can be arranged on the seat support.

For example, the at least one seat support can be connected to the transfer unit using quick connectors, such as a plug connector, a carabiner or safety carabiners, which are known from climbing sports. This can considerably simplify handling and reduce the time the at least one vehicle spends at the entry and/or exit region. The transfer unit can also comprise one or more hooks, for example, into which loops or fabric loops of the seat support can be hooked.

A further embodiment of the present invention provides that second connecting means are arranged to enable the seat support to be attached to the receiving area. The second connecting means ensure that the seat support can be attached to the vehicle properly and in accordance with regulations during the ride on the amusement ride and that the seat support does not pose a potential danger to other occupants.

Typically, the second connecting means comprise a first and second connecting means part which interact with one another. The first connecting means part can be firmly arranged on the receiving area and the second connecting means part can be arranged on the seat support. The second connecting means part of the first connecting means can be the second connecting means part of the second connecting means.

For example, the second connecting means may comprise at least one carabiner, at least one eyelet and/or at least one hook into which, for example, the at least one loop or fabric loop already mentioned above can be hooked. In such an exemplary embodiment, the loop also forms the second connecting means part of the first connecting means.

A further embodiment of the present invention provides that the transfer unit comprises at least one holding bracket, to the free end regions of which the seat support can be attached, preferably by means of the first connecting means. The at least one holding bracket stretches the seat support in the manner of a hammock, seat mat, beanbag or similar and can provide at least one occupant with a means of holding on.

A further embodiment of the present invention provides that the at least one receiving area comprises a retaining system which can securely hold the at least one occupant in the receiving area. The retaining system of the at least one receiving area can, for example, be designed as a safety bar. The retaining system can be moved-preferably by a pivoting movement between an open position and a closed position, wherein in the open position the at least one occupant can take a seat on the receiving area or the seat surface of the receiving area. In the closed position, the at least one occupant is preferably held in the receiving area in a form-locking manner.

According to a preferred further embodiment of the present invention, the at least one holding bracket is C-shaped or U-shaped. The C-shaped or U-shaped at least one holding bracket can surround a clear region, wherein the clear region corresponds to a region within which the safety bar can be arranged in and between the open and closed positions.

The C- or U-shaped design of the holding bracket makes it possible, for example, to position the seat support or the occupant on the seat support in the open position of the occupant restraint and the occupant restraint on the receiving area. This design can also make it possible to first establish a connection between the seat support and the transfer unit after a ride with the amusement ride before the occupant restraint is moved from the closed position to the open position. The transfer unit can therefore also be used in emergency situations to evacuate at least one occupant.

An advantageous embodiment according to the present invention provides that the at least one holding bracket is held on the transfer unit in an approximately horizontal orientation. In the context of the present invention, approximately horizontally oriented can be understood to mean an orientation of the holding bracket of ±45° to the horizontal. This ensures that, on the one hand, the holding bracket can position the seat support over the at least one receiving area or the seat surface of the at least one receiving area when used as intended and, on the other hand, provides the occupant with a means of holding on. In another description, the holding bracket is arranged on the transfer unit in such a manner that the at least one holding bracket embraces the clear area in a transverse plane of the seat support.

Furthermore, an advantageous embodiment according to the present invention provides that the at least one holding bracket is held approximately vertically on the transfer unit. The at least one holding bracket embraces-vertically oriented-the clear area and can preferably be fork-shaped in order to stretch the seat support, which can be attached to the free end areas, in the manner of a hammock, seat mat, beanbag or similar. Approximately vertical in the context of the present invention can be understood to mean an orientation of ±30° to the vertical. In another description, the holding bracket is arranged on the transfer unit in such a manner that the at least one holding bracket embraces the clear area in a sagittal plane or a frontal plane of the seat support.

A preferred further embodiment of the present invention provides that the transfer unit comprises a lifting device, which can be positioned above the entry and exit region and the at least one receiving area. The lifting device can either be designed like a crane with a jib or like a gantry crane. The at least one vehicle can drive under the lifting device at the entry and exit region, wherein the boom or runner can be positioned above the receiving area of the at least one vehicle. Furthermore, at least one holding means can be provided that connects the lifting device to the at least one holding bracket. Preferably, the holding means is rope-shaped, which allows a simple rotational movement between the lifting device and the at least one holding bracket.

Furthermore, it has proven to be advantageous if the transfer unit has a drive that can at least raise and/or lower the seat support.

A further aspect of the present invention relates to a method of operating a previously described amusement ride. The method has the following method steps:
connecting the seat support to the transfer unit,
lifting and subsequent transporting of the at least one occupant arranged on the seat support from the entry and exit region via the at least one receiving area, in particular of the at least one vehicle, and setting down on the at least one receiving area, or
lifting of the at least one occupant arranged on the seat support from the receiving area and subsequent transporting to the entry and exit region and lowering and setting down of the at least one occupant, and
releasing the connection between the seat support and the transfer unit.

A preferred further embodiment of the method described above provides for the seat support to be connected to the at least one vehicle, in particular to the receiving area, after the connection between the seat support and the transfer unit has been released.

In the following, with reference to the accompanying drawings, several scenes of an embodiment of an amusement ride, in particular a roller coaster, according to the invention are described in detail. In the figures:

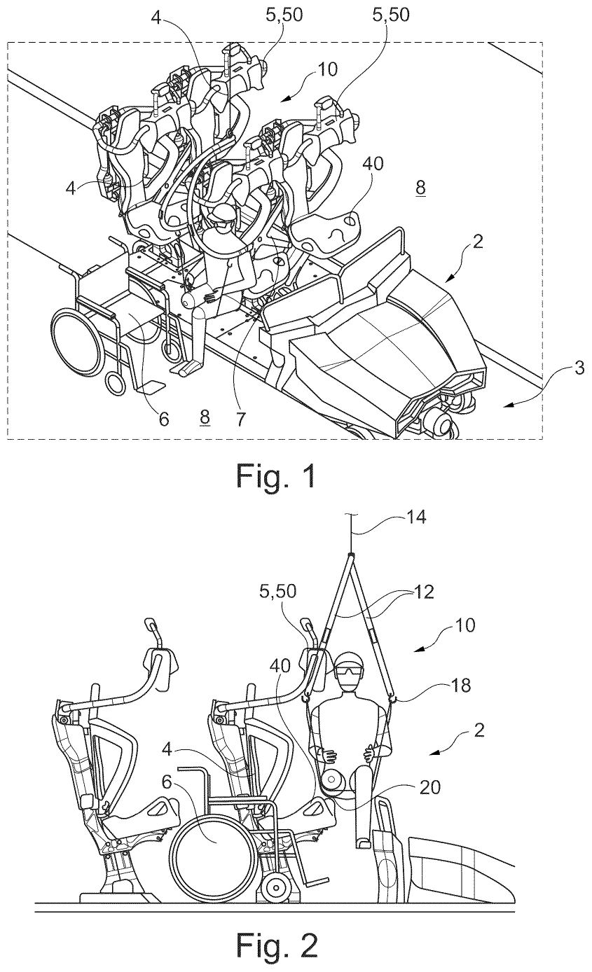

FIG. 1 is a perspective view of an amusement ride with a vehicle having a plurality of receiving areas for occupants, which is movable along a route, wherein an entry and exit region is arranged along the route, in which at least one occupant can be lifted from the entry and exit region into the receiving area by means of a transfer unit and a seat support which can be attached to the transfer unit,

FIG. 2 is a side view of the amusement ride shown in FIG. 1,

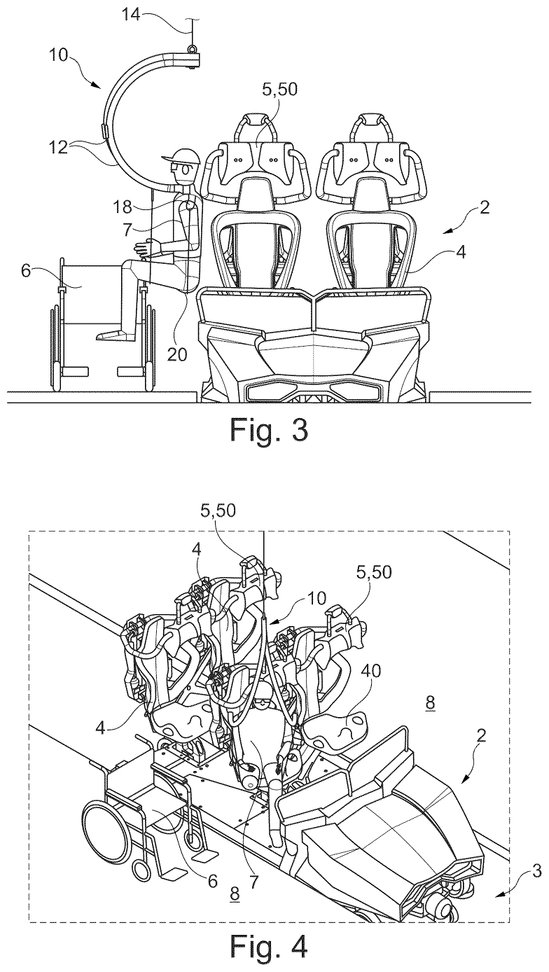

FIG. 3 is a front view of the amusement ride shown in FIG. 1,

FIG. 4 is a perspective view of another scene during the implementation of the method for operating the amusement ride,

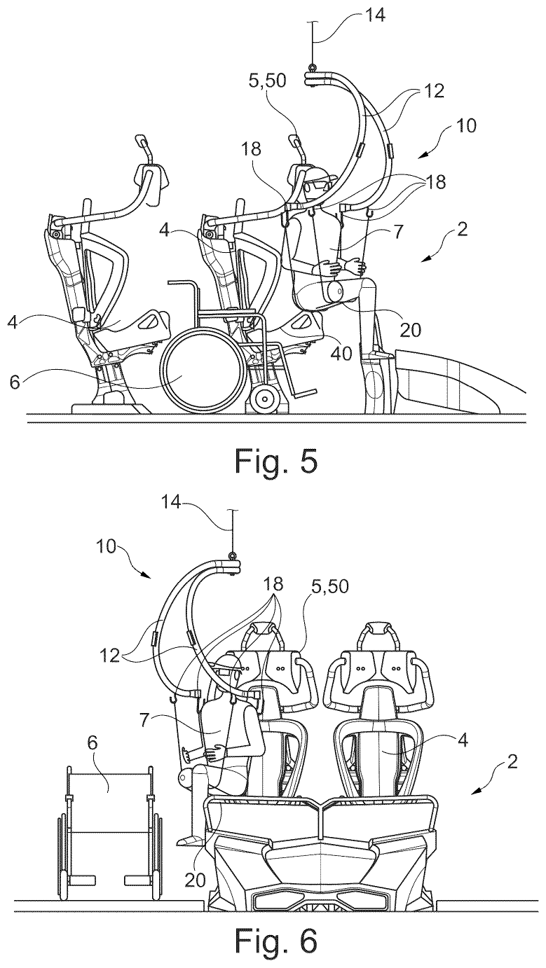

FIG. 5 is a side view of the scene shown in FIG. 4,

FIG. 6 is a front view of the scene shown in FIGS. 4 and 5,

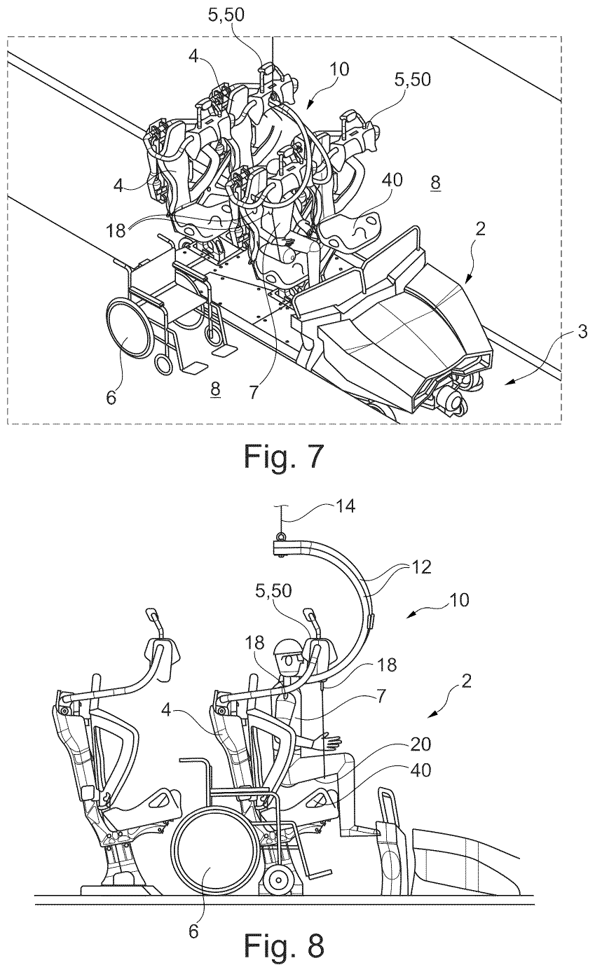

FIG. 7 is a perspective view of a further scene during the implementation of the method for operating the amusement ride according to the preceding figures,

FIG. 8 is a side view of the scene shown in FIG. 7,

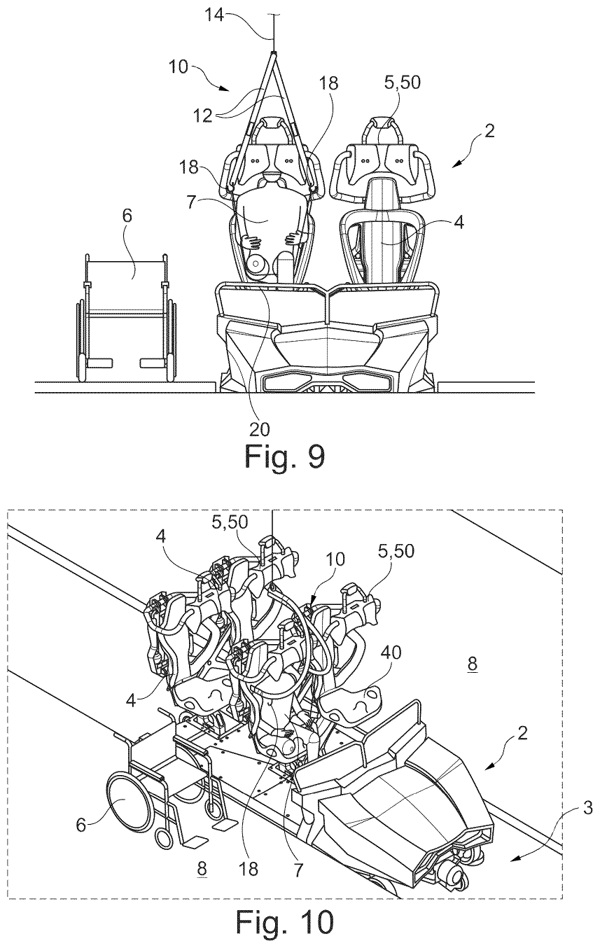

FIG. 9 is a front view of the scene shown in FIGS. 7 and 8,

FIG. 10 is a perspective view of a further scene during the implementation of the method for operating the amusement ride according to the preceding figures,

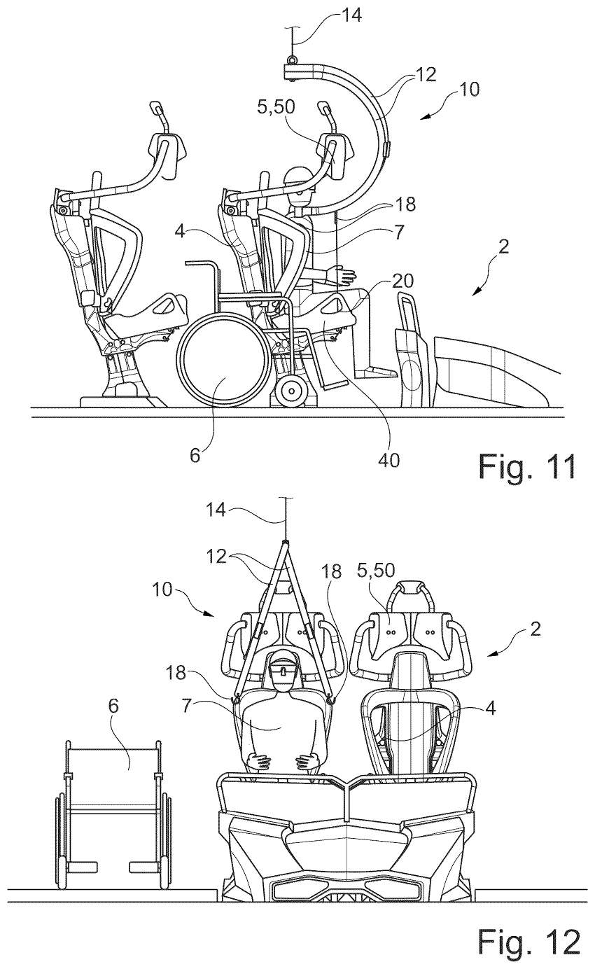

FIG. 11 is a side view of the scene shown in FIG. 10, and

FIG. 12 is a front view of the scene shown in FIGS. 10 and 11.

In the following, identical or functionally identical components are identified with the same reference symbols. For the sake of clarity, not all identical or functionally identical parts are given a reference number in the individual figures.

FIGS. 1 to 12 show different scenes in an amusement ride 1 that is, for example, a roller coaster, a water ride, a dark ride, a carousel or a roundabout.

The amusement ride 1 comprises at least one receiving area 4 which can be moved along a route 3, not shown in detail, for the entertainment of at least one occupant 7. The at least one receiving area 4 can preferably be arranged on a vehicle 2.

The amusement ride 1 further comprises an entry and exit region 8, which is arranged next to the route 3. The at least one vehicle 2 can stop at the entry and exit region 8 before and/or after a journey so that occupants 7 can get off and/or on.

The at least one vehicle 2 comprises at least one, in the present case several, receiving areas 4, wherein the respective receiving area 4 may comprise a seat surface 40 on which the at least one occupant 7 can be arranged in a seated position during the ride with the amusement ride 1.

In addition, the at least one vehicle 2 comprises one or more occupant restraints 5, wherein in the illustrated embodiment example the occupant restraint 5 is designed as a safety bar 50, which is configured to hold the at least one occupant 7 in the receiving area 4, preferably in a form-locking manner.

The safety bar 50 can be pivoted from an open position as shown in FIGS. 1-12 to a closed position (not shown), wherein the occupant 7 can be arranged in the receiving area 4 in the open position. In the closed position, the occupant 7 can preferably be held in the receiving area 4 in a form-locking manner. The region in which the safety bar 50 moves between the open and closed positions is referred to as the clear region in the context of the present invention.

The entry and exit region 8 can, for example, be part of a station (not shown in full). The at least one occupant 7 can enter the at least one vehicle 2 from the entry and exit region 8, preferably at ground level and even more preferably barrier-free, or can exit the vehicle after completing the ride on the amusement ride 1.

As shown in FIGS. 1, 3, 4, 6, 7, 9, 10 and 12, the entry and exit region 8 in the station can be formed on both sides of the route 3 to enable throughput-optimized operation.

Referring to FIGS. 1-12, various scenes are shown, in particular how a occupant 7, who is unable to independently board the at least one vehicle 2 from the entry and exit region 8 due to a physical limitation, is lifted from the entry and exit region 8 into one of the receiving areas 4 of the at least one vehicle 2 by means of a transfer unit 10.

The transfer unit 10 comprises at least one holding bracket 12, on which a seat support 20 can be held or detachably suspended in the manner of a hammock. In the illustrated embodiment example, the transfer unit 10 comprises two holding brackets 12.

The seat support 20 can be detachably connected to the transfer unit 10 via first connecting means 18 (not shown in detail), wherein the first connecting means 18 comprise, for example, a first connecting means part arranged on the holding bracket 12. The first connecting means 18 may further comprise a second connecting means part arranged on the seat support 20.

For example, the first connecting means part may comprise an eyelet or a hook on the holding bracket, and the second connecting means part may comprise a loop, a shackle, a carabiner or similar, which may cooperate with the first connecting means part to form the releasable connection.

The seat support 20 can be designed as a seat mat, seat belt, beanbag, seat cloth or similar and can be provided to the at least one occupant 7 when entering the amusement ride 1 or already when entering the amusement park-also together with a walking aid or a means of occupant transportation 6, e.g. a wheelchair.

The occupant 7 can be arranged on the seat support 20 and enter the entry and exit region 8 of the amusement ride 1 with the occupant transportation means. It is also possible to arrange the occupant 7 on the seat support 20 only in the entry and exit region 8.

The holding bracket 12 according to the embodiment example in FIGS. 1 to 4 is C-shaped or U-shaped and has two free end regions to which the seat support 20 can be attached.

The two holding brackets 12 embrace the at least one occupant 7 in its transverse plane, wherein the two holding brackets 12 are preferably dimensioned in such a manner that they can also embrace the safety bar 50 or the occupant receiving area 4 or the clear region of the safety bar 50 in a transverse plane of the occupant receiving area 4.

The holding brackets 12 can be connected to a lifting device (not shown) of the transfer unit 10 via a holding means 14, which is shown in a highly simplified manner, and can lift the at least one occupant 7 from the entry and exit region 8 into or onto one of the receiving areas 4 of the at least one vehicle 2. In particular, the transfer unit 10 can perform a lifting and lowering movement and a translational movement. The lifting device can be designed as a crane with a jib, for example, and can also comprise a runner or jib.

The lifting and lowering movement, which is performed for example in the scenes of FIGS. 8 to 12, serves to lift the at least one occupant 7 into or out of the at least one receiving area 4 and/or the occupant transportation means 6 and/or walking aid. The translational movement, which is carried out for example in the scenes of FIGS. 1 to 7, serves to transport the at least one occupant 7 from the entry and/or exit region 8 into or onto the at least one vehicle 2. A rotational movement enables it to be swiveled in and out, for example onto a seat surface of the occupant transport means 6 and/or the seat surface 40 of the receiving area 4.

First, as already mentioned, the occupant 7 may be provided with a corresponding seat support 20.

The occupant 7 can enter the amusement ride 1 or the entry and exit region 8 of the amusement ride 1 and the seat support 20 can be connected to the transfer unit 10. Either the occupant 7 can already be seated on the seat support 20, for example in his occupant transportation means 6, or the occupant 7 can be arranged in the seat support 20 suspended in the transfer unit 10.

As soon as the at least one vehicle 2 is provided at the entry and exit region 8 for travel with the amusement ride 1, the occupant 7, see FIG. 1 or 2, can be lifted and lowered from the entry and exit region 8 into the intended receiving area 4, see FIGS. 4 to 12. For this purpose, the safety bar 50 is in the open position.

As soon as the occupant 7 is lowered into the receiving area 4 or onto the seat surface 40 of the receiving area 4, the first connecting means 18 can be opened and the seat support 20 can be separated from the transfer unit 10.

Subsequently, the seat support 20 can be connected to the vehicle 2 by second connecting means 19 (not fully shown) so that the seat support 20 is properly and correctly attached to the vehicle 2 during the ride with the amusement ride 1 and so that the seat support does not pose a potential danger to other occupants 7.

The transfer unit 10 or the holding bracket 12 can then be moved away from the vehicle 2 so that the vehicle 2 can depart for the amusement ride 1.

After the ride on the amusement ride 1, the vehicle 2 stops again at the entry and exit region 8. The transfer unit 10 can be repositioned at the corresponding receiving area 4 and, after the second connecting means 19 have been released, a connection can be established between the seat support 20 and the transfer unit 10 by means of the first connecting means 18 in order to lift the occupant 7 out of the receiving area 4 and transport the occupant 7 back to the entry and exit region 8 and set them down there. Here, for example, the occupant 7 can be set down again with the seat support 20 on his means of occupant transport 6 and the connection between the seat support 20 and the transfer unit 10 can be disconnected.

The two holding brackets 12 surround the clear region in a sagittal plane of the receiving area 4. The holding brackets 12 can be described as being arranged in a fork-shaped manner, wherein the first connecting means portion of the first connecting means 18 is arranged at the two free end regions. As illustrated, the two holding brackets 12 can be formed from two individual brackets that diverge in a V-shape from a connecting portion to form the fork shape to the free end regions. It should be noted at this point that the two holding brackets 12 can also be formed in one piece.

### LIST OF REFERENCE SYMBOLS

1 amusement ride
2 vehicle
3 route
4 receiving area
5 occupant restraint
6 wheelchair
7 occupant
8 entry and exit region
10 transfer unit
12 holding bracket
14 holding means
18 first connecting means
19 second connecting means
20 seat support
40 seat surface
50 safety bar

1. An amusement ride (1), in particular a roller coaster, having
at least one receiving area for at least one occupant (7),
and an entry and/or exit region (8),
wherein a transfer unit (10) is arranged in the entry and/or exit region (8), and
wherein the transfer unit (10) can lift the at least one occupant (7) on a seat support (20) from the entry and/or exit region (8) onto the at least one receiving area (4).

2. The amusement ride (1) according to claim 1,
characterized in that
the transfer unit (10) can perform a lifting and lowering movement and a translation.

3. The amusement ride (1) according to claim 1,
characterized in that
the seat support (20) is flexible, in particular in that the seat support (20) comprises a seat mat, a support cloth, a seat shell or a beanbag.

4. The amusement ride (1) according to claim 1,
characterized in that
first connecting means (18) are provided for forming a releasable connection between the transfer unit (10) and the seat support (20).

5. The amusement ride (1) according to claim 1,
characterized in that
second connecting means (19) are provided for fastening the seat support (20) to the at least one vehicle (2).

6. The amusement ride (1) according to claim 1,
characterized in that
the transfer unit (10) comprises at least one holding bracket (12) to which the seat support (20) can be attached.

7. The amusement ride (1) according to claim 6,
characterized in that
the holding bracket (12) is U-shaped or C-shaped.

8. The amusement ride (1) according to claim 1,
characterized in that
the at least one receiving area (4) comprises a occupant restraint (5) which can hold the at least one occupant (7) in the receiving area (4), preferably in a form-locking manner.

9. The amusement ride (1) according to claim 1,
characterized in that
the holding bracket (12) embraces a clear region in which the occupant restraint (5) can be moved between an open and a closed position.

10. The amusement ride according to claim 1,
characterized in that
the transfer unit (10) comprises a lifting device which can be positioned above the entry and/or exit region (8) and the at least one receiving area (4).

11. The amusement ride (1) according to claim 1,
characterized in that
the transfer unit (10) has a drive by means of which the lifting and lowering can take place at least with drive support.

12. A method of operating an amusement ride (1), in particular an amusement ride (1) claim 1, having the following method steps:
connecting a seat support (20) to a transfer unit (10),
lifting and subsequent transporting of an occupant (7) arranged on the seat support (20) from an entry and exit region (8) via a receiving area (4) and lowering and depositing of the seat support (20) on the receiving area (4) or
lifting of a occupant (7) arranged on a seat support (20) from a receiving area (4) and subsequent transporting to an entry and exit region (8) and lowering and depositing of the seat support (20),
releasing the connection between the seat support (20) and the transfer unit (10).

13. The method according to claim 12,
characterized in that
after lowering and setting down, a connection is established between the seat support (20) and the transfer unit (10) or a means of occupant transport (6), in particular a wheelchair.
